(19) United States
(12) Patent Application Publication
(10) Pub. No.: US 2014/0131532 A1
(43) Pub. Date: May 15, 2014

(54) Ladder Securing Device

(71) Applicant: Henry A. Elmore, Mobile, AL (US)

(72) Inventor: Henry A. Elmore, Mobile, AL (US)

(21) Appl. No.: 14/020,803

(22) Filed: Sep. 7, 2013

Related U.S. Application Data
(60) Provisional application No. 61/698,606, filed on Sep. 8, 2012.

(51) Int. Cl. E06C 7/18

(52) U.S. Cl. CPC E06C 7/188
USPC 248/201

(57) ABSTRACT

A stabilizing device that will secure extension ladder to the roof of a house. Device is compact and light in weight and permanently installs on ladder. The core components of the invention are arm assemblies with pivoting feet, connecting point for chain and bracket for clamp storage, a connecting chain, and modified hold down clamps. Configuration is as follows: Arm assemblies with pivoting feet attach (bolt) directly to ladder, the pivoting feet will self-adjust to the pitch of the roof. The modified hold down clamps that are attached to the arms by a very short chain, are then clamped to the lowest run of shingles. It should be further noted that the pivoting feet are adjustable to allow ladder to be placed at a roof gable, also note that the feet and clamps are padded at the shingle contact point to enhance grip and prevent shingle damage.

### FIELD OF INVENTION

A ladder equipped with this device will be stabilized and secured to the house. Device allows ladder to stand off of the house and never touch shingles or gutter system. Device is permanently installed on ladder and requires no tools for daily use. Device is light in weight and compact in size. Device is compatible with all manner of free standing ladders.

### BACKGROUND OF INVENTION

Currently there are a number of solutions for stabilizing a ladder that have a US Patent number including the following—Misiak U.S. Pat. No. 7,377,360B—Xu U.S. Pat. No. 0,175,188A—Hastreiter U.S. Pat. No. 6,394,229B—Davis Jr U.S. Pat. No. 0,160,607—Werner U.S. Pat. No. 3,568,801. All of the above patents have various drawbacks. Most of these devices do not allow for securing the ladder to the house. Some of these devices are big and heavy in construction. Some are not permanently installed on the ladder. Some do not allow ladder to be fully collapsed. Some will not work on all manner of extension ladders. Some are complicated and/or require time consuming setup and adjustment upon each use. All of the above patents incorporate more than one of these deficiencies.

Most in the industry (ladder users) use their ladders with no safety or securing device what so ever due to the available devices being:
1. Too bulky and or heavy
2. Setup/take down is too complicated and or difficult
3. Ladder & device become separated.

Simply leaning a ladder against a house can easily cause damage to gutter system and or roofing system. Some use nothing more than a bungee cord or rope to tie off their ladder. This method is insufficient because there is not always something to tie off to. While tying off in this manner will prevent a blow over it will do little or nothing to increase safety.

Therefore, there currently exists a need in industry for a device that is permanently attached to the ladder, that is light in weight, that is compact in size, that will increase user safety, that will not cause damage, all while being simple and easy to use.

### OBJECTS & SUMMARY OF THE INVENTION

It is an object of this invention to provide a safer and easier way to access a roof without causing damage to shingles and or gutters.

Additional objects of this invention are to provide a device that is permanently mounted, simple, compact, light in weight and easy to use.

Another object of this invention is to provide a device that is in harmony with the widely accepted American ladder safety guidelines.

A further object of this invention is to provide a device that does not suffer from the deficiencies associated with prior solutions.

### SUMMARY OF THE INVENTION

The present invention is a Ladder Securing Device, which is made up of the following components: (1) Arm Assemblies with welded bracket for clamp storage, welded bracket for mounting to ladder fly, and welded attaching point for the chain. (2) Backing Plate. (3) Self Aligning Foot. Foot will also adjust so as to allow proper alignment when ladder is placed at the top of a gable. The Foot will have a padded, contact area. (4) A short chain will connect the Tubular Arm and a (5) Modified Hold Down Clamp. The modified hold down clamp will have a padded contact area. There is a left and right for every component.

The bracket that attaches the Tubular Arm to ladder fly, will mount below the third rung from the top of the ladders Fly Section. It will have a Backing Plate, in effect creating a sandwich with the ladders fly in the middle, these pieces are bolted to the fly with three bolts. This will assure that the fly will not have a loss of structural integrity. The Foot will mount to the end of the Tubular Arm with a removable pin. A modified hold down clamp will be attached to the tubular arm by a short connector chain. These clamps will attach this entire system, ladder and all, to the roof of the house.

### HOW THIS DEVICE IS DIFFERENT

The present invention is structurally different from other known ladder securing and/or stability devices or solutions. More specifically the present invention is unique when compared with other known devices and solutions due to the following qualities:
1. Lightweight—for ease of use.
2. Permanent Instillation—for convenience.
3. Compact Design—for convenience.
4. No Tools Needed—for convenience.
5. Safe, Roof Access—in harmony with American ladder safety guidelines.
6. No Damage to Shingles or Gutters—ladder never makes contact with shingles or gutter.
7. Padded Shingle Contact Area—to improve grip and to prevent damage.
8. Simple Operation—for convenience.

### BRIEF DESCRIPTION OF DRAWINGS

FIG. 1 shows left and right assemblies.

FIG. 2 shows the clamp assembly.

FIG. 3 shows and expanded view of the left arm assembly with the pivoting foot.

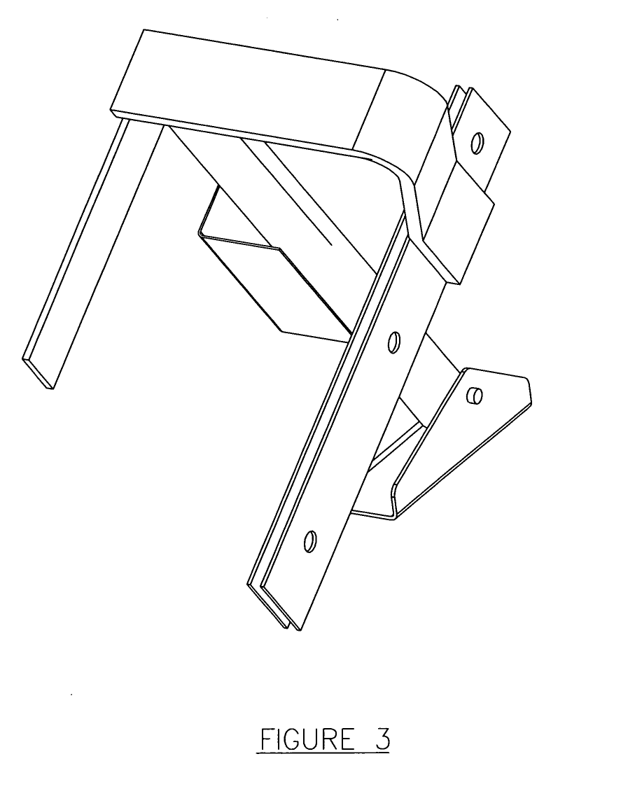

FIG. 4 shows and expanded view of the right arm assembly with the pivoting foot.

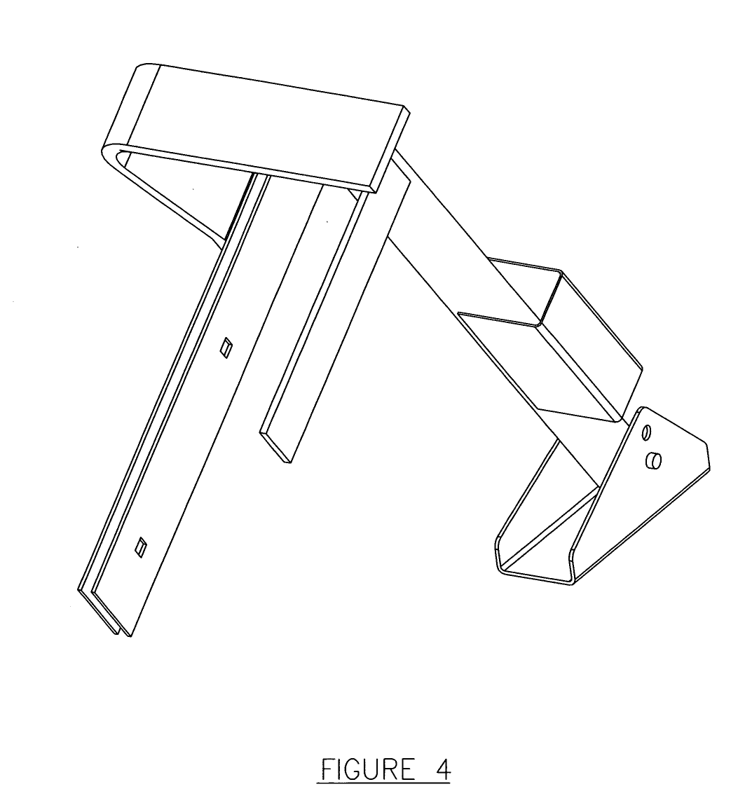

FIG. 5 shows an over view of the device on a ladder at the eave.

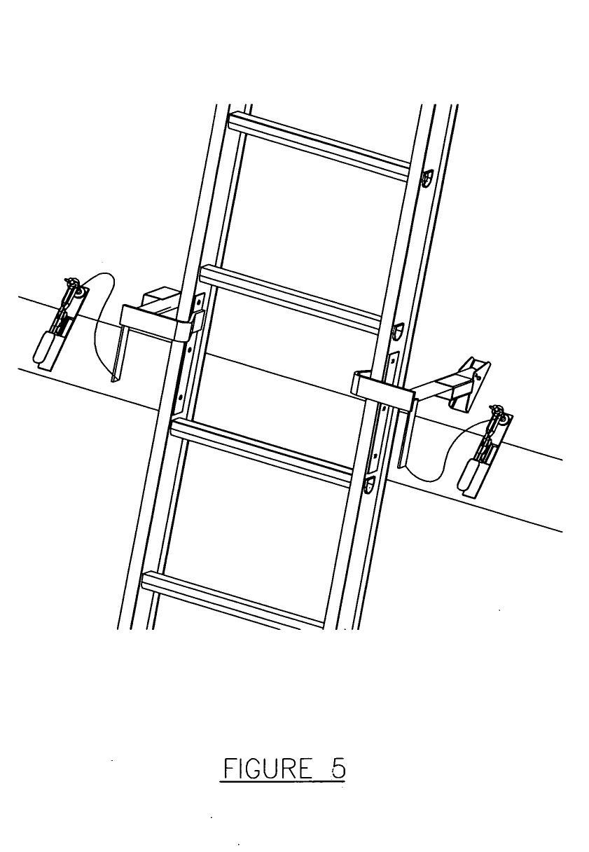

FIG. 6 shows a profile view of the device on a ladder at the eave.

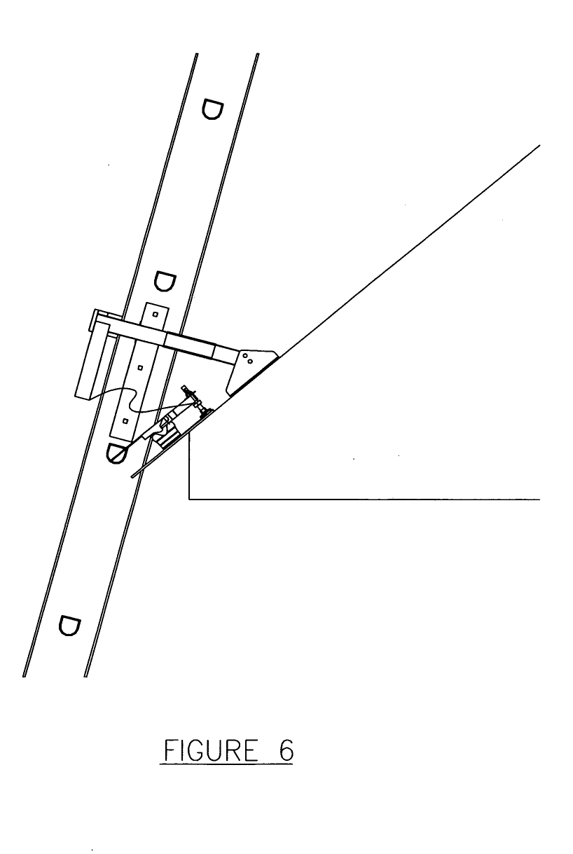

### DETAILED DESCRIPTION

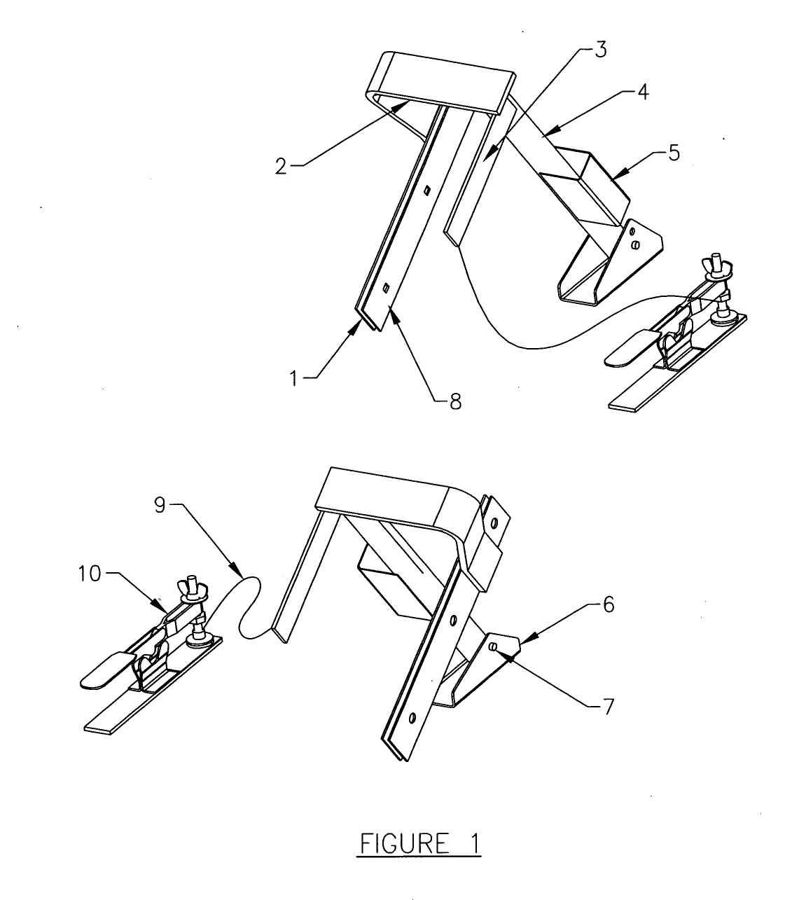

FIG. 1

The various components of FIG. 1 are Arm Assembly, Connecting Chain, and Clamp.

The Arm Assembly consist of the following:

#1 Mounting Bracket is bolted directly to the ladder fly section, between the third and fourth rung from the top, this location will allow the ladder to extend three feet above the eave, which will allow the user to be in compliance with widely recognized ladder safety guidelines. The mounting bracket fastens on the inside of the fly while the #8 Backing Plate mounts on the outside of the fly, these two pieces are what secures the device to the ladder, and assure that there is no compromise in structural integrity of the ladder. Component #2 goes up and over the top of the fly allowing for clearance of the alignment clips found on the top of all fiberglass extension ladders, clearing these clips allows the ladder to be fully collapsed. Component #3 is a drop down to allow for proper positioning of the chain that extends to the clamp. Component #4 is a tubular piece that extends over the eave and onto the roof, it has a hole at the end for a pivot pin. Component #6 is the foot, it is uniquely designed with counterweight which allows for prefect alignment to the roof and requires no additional effort on the part of the ladder user. It is also adjustable so the ladder can be set up at the top of a gable roof. The foot is attached to the tube #4 with a pin #7. Component #5 is a bracket for clamp storage, it is mounted on the side of tubular arm #4 and when not in use, the clamp #10 mounts securely and neatly to this bracket. Component #9 is a section of chain that mounts at the lower point of the #3 drop down and attaches to the #10 clamp, effectively connecting the clamp to the arm assembly.

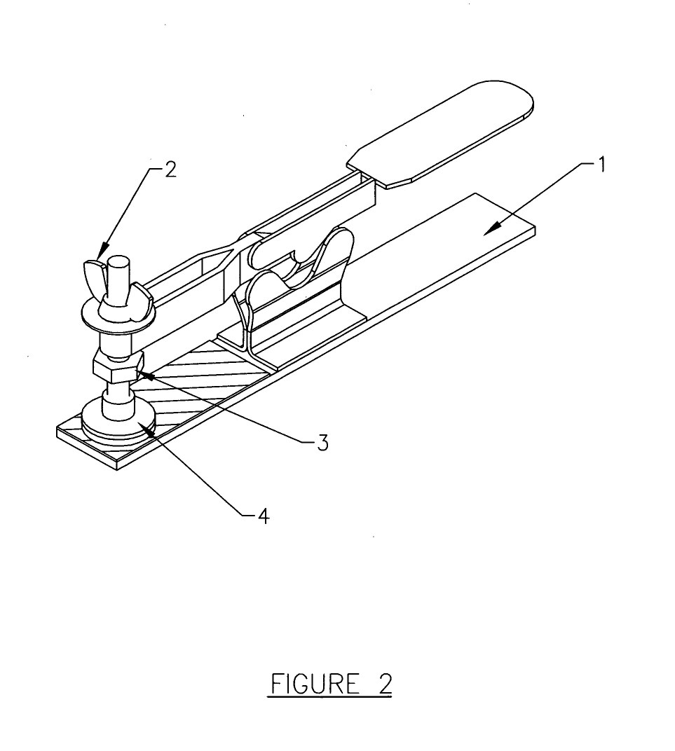

FIG. 2

The various components of FIG. 2 are Clamp, Wing Nut, Jamb Nut and Elevator Bolt.

The clamp #1 has a base that extends under the handle allowing the user easy one handed operation. It also has an elevator bolt #4 that has a padded shingle contact area. A jamb nut #3 and wing nut #2 allow the elevator bolt #4 to be adjusted to shingles of various thicknesses.

In its most complete version, this Ladder Stabilizing/Securing Device is made up of the following components: It has arm assemblies with pivoting feet, a connector chain and hold down clamps. These components are connected as follows: The arm assemblies with pivoting feet attach (bolt) directly to ladder, the pivoting feet will self-adjust to the pitch of roof. Pivoting feet are also adjustable so that they will align to roof when the ladder is placed at the top of a gable. It also has hold down clamps that attach to the arms by a very short chain, they are then clamped to the lowest run of shingles. When not in use the clamps will clamp to a bracket on the side of the arm. Both the clamps and feet are padded at their shingle, contact point to improve their grip and prevent shingle damage.

While the present invention has been described above in terms of specific, preferred embodiment, it is to be understood that the invention is not limited to these disclosed embodiments. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed:

1. A stabilizing device for permanent mounting to the upper end of all manner of free standing ladders, that is in compliance with all the widely recognized American ladder safety guidelines, and gives the user safe and easy access to most all roofing systems. Said stabilizing device comprising of a left and a right unit. The device is permanently mounted in such a way as to allow the ladder to extend 3 feet above the eave.

2. Said device will allow ladder to stand off of the roofing and gutter systems.

3. Said device will allow ladder to be attached to the roofing system.

4. Said device will change the weight distribution, it will now be over 4 points instead of 2, furthermore, as the user gets higher up the ladder, more and more weight will be distributed to the roof contact points, and less and less weight will be distributed to the ground contact points.

5. Said device will have padded, non-slip contact areas.
